(19) United States
(12) Patent Application Publication
(10) Pub. No.: US 2022/0346329 A1
(43) Pub. Date: Nov. 3, 2022

(54) MULTI-CORNER IRRIGATION SYSTEM HAVING MULTIPLE STEERABLE POINTS WITHIN MOBILE IRRIGATION MACHINE AND METHOD FOR IMPLEMENTING THE SAME

(71) Applicant: Valmont Industries, Inc., Omaha, NE (US)

(72) Inventor: John Kastl, Wahoo, NE (US)

(73) Assignee: Valmont Industries, Inc., Omaha, NE (US)

(21) Appl. No.: 17/715,991

(22) Filed: Apr. 8, 2022

Related U.S. Application Data
(60) Provisional application No. 63/183,157, filed on May 3, 2021.

(51) Int. Cl. A01G 25/09; A01G 25/16

(52) U.S. Cl. CPC A01G 25/092; A01G 25/16

(57) ABSTRACT

The present invention provides a multi-corner irrigation system having multiple steerable points which can quickly and efficiently irrigated tight corners during irrigation operations. According to an exemplary preferred embodiment, the present invention may preferably include a system for use with a self-propelled irrigation system having at least one span and a drive system for moving the span. According to a further preferred embodiment, the system preferably may include: a main section assembly having one or more interconnected spans supported by one or more drive towers; a first articulated span having an inner end and an outer end; a second articulated span having an inner end and an outer end; and an extension span. According to a further preferred embodiment, the first and second articulating spans are supported by a first drive tower which is steerable and a second drive tower which is steerable.

### RELATED APPLICATIONS

The present application claims priority to U.S. Provisional Application No. 63/183,157 filed May 3, 2021.

### BACKGROUND AND FIELD OF THE PRESENT INVENTION

### Field of the Present Invention

The present invention relates generally to irrigation machines and, more particularly, to a multi-corner irrigation system having multiple steerable points within a mobile irrigation machine.

### Background of the Invention

Modern field irrigation machines are combinations of drive systems and sprinkler systems. Generally, these systems are divided into two types depending on the type of travel they are designed to execute: center pivot and/or linear.

Regardless of being center pivot or linear, common irrigation machines most often include an overhead sprinkler irrigation system consisting of several segments of pipe (usually galvanized steel or aluminum) joined together and supported by trusses, mounted on wheeled towers with sprinklers positioned along its length. These machines move in a circular pattern (if center pivot) or linear and are fed with water from an outside source (i.e. a well or water line). The essential function of an irrigation machine is to apply an applicant (i.e. water or other solution) to a given location.

FIG. 1 illustrates an exemplary self-propelled irrigation system 100 as known in the prior art. As shown, common self-propelled irrigation systems 100 generally may include spans 102, 104, 106 supporting drive towers 108, 109, 110. Further, each drive tower 108, 109, 110 is shown with respective drive controllers 112, 113, 114. For each drive tower, 108, 109, 110, the respective drive controllers 112, 113, 114 may generally control respective drive motors 117, 119, 120 and drive wheels 115, 116, 118. Further, such irrigation machines 100 may generally include an extension/overhang 121 which may include an end gun (not shown).

In use, current irrigation systems such as the system illustrated in FIG. 1 are often unable to reach and properly irrigate tight corners. This presently results in significant portions of a given field being poorly and/or unevenly irrigated. To water these tight corners, present systems rely heavily on end guns which are difficult to aim and control. Further, even when used properly, the end guns are unable to fully irrigate tight corners without significant overspray.

To address these problems, some systems of the prior art incorporate corner arms attached in place of the extension/overhang 121. However, these types of systems are limited by the length and maximum extension speed of the corner arm. Further, even with a corner arm there are a number of field types (rectangular, odd-shaped borders, etc.) that cannot be properly irrigated even by a single span corner arm due to limitations in length of the span and/or the ability of the span to extend quickly enough while providing adequate irrigation that can be absorbed by the soil. Another attempt to address these problems is the use of a multi-span arm which includes a semi-independent linear span with two or more drive units attached to the end of the irrigation machine by connecting spans. However, these and other similar configurations have been proven to be susceptible to high structural stresses and fatigue failure of the linear span. These stresses may be caused by torque created by having drive units mounted to each end of linear span which “skid-steer” the span through the field in order irrigate the assigned area. Further, these designs are limited to the overall the length of the corner arm connecting span plus the semi-independent linear span, and the amount of extension and retraction is limited by the geometry of the “Z” shape of the arms when retracted.

In order to overcome the limitations of the prior art, a system is needed which is able to quickly and efficiently irrigate tight corners, the wide boundary side of rectangular fields and fields with irregular or unusually shaped boundaries without limiting the possible extension length.

### SUMMARY OF THE DISCLOSURE

To minimize the limitations found in the prior art, and to minimize other limitations that will be apparent upon the reading of the specifications, the present invention provides a multi-corner irrigation system having multiple steerable points which is able to quickly and efficiently irrigated tight corners during irrigation operations.

According to a first exemplary embodiment, the present invention may preferably include a system for use with a self-propelled irrigation system having at least one span and a drive system for moving the span. According to a further preferred embodiment, the system preferably may include: a main section assembly having one or more interconnected spans supported by one or more wheeled towers; a first articulated span having an inner end and an outer end; a second articulated span having an inner end and an outer end; and an overhang span.

According to a further preferred embodiment, the present invention may preferably include a system for use with a self-propelled irrigation system having at least one span and a drive system for moving the span. According to a further preferred embodiment, the system preferably may include: a main section assembly having one or more interconnected spans supported by one or more wheeled towers; a first articulated span having an inner end and an outer end; a second articulated span having an inner end and an outer end; a third articulated span having an inner end and an outer end; and an overhang span.

According to a further preferred embodiment, the present invention may preferably include a system for use with a self-propelled irrigation system having at least one span and a drive system for moving the span. According to a further preferred embodiment, the system preferably may include: a main section assembly having one or more interconnected spans supported by one or more wheeled towers; a first articulated span having an inner end and an outer end; a second articulated span having an inner end and an outer end; any number of additional articulated spans having an inner end and an outer end; and an overhang span.

According to a further preferred embodiment, the present invention may preferably further include: a first connecting joint which attaches the main section assembly to a water source; a first articulating joint attached to the main section assembly and rotationally connected to the inner end of the first articulated span; a second articulating joint rotationally attached to the outer end of the first articulated span and rotationally connected to the inner end of the second extension articulated span; a first drive tower which is steerable; a second drive tower which is steerable; and an overhang/extension span.

### BRIEF DESCRIPTION OF THE DRAWINGS

FIG. 1 shows an exemplary irrigation system of the prior art.

FIG. 2 shows an illustration of an exemplary irrigation machine in accordance with a preferred embodiment of the present invention.

FIG. 3 shows an overhead view of an exemplary irrigation machine as shown in FIG. 2.

FIG. 4 shows an overhead view of an exemplary irrigation machine as shown in FIG. 2 in articulated positions.

FIG. 5 shows a first example connection type in accordance with a preferred embodiment of the present invention.

FIG. 6 shows a connection system in accordance with a preferred embodiment of the present invention.

FIG. 7 shows an exploded view of the connection system shown in FIG. 6.

FIG. 8 shows an exploded view of the cradle assembly of the connection system shown in FIG. 6.

FIG. 9 shows a diagram of an alternative connection system in accordance with an alternative preferred embodiment of the present invention.

FIG. 10 shows a second example connection type in accordance with a preferred embodiment of the present invention.

FIG. 11 shows an exploded view of the connection system shown in FIG. 10.

FIG. 12 shows an exploded view of a portion of the connection system as indicated in FIG. 11.

FIG. 13 shows a first example configuration for the connection of the system of the present invention.

FIG. 14 shows a second example configuration for the connection system of the present invention.

FIG. 15 shows a third example configuration for the connection system of the present invention.

FIG. 16 is a diagram illustrating exemplary method steps in accordance with a preferred embodiment of the present invention.

FIG. 17 is a diagram illustrating additional steps to the method shown in FIG. 16.

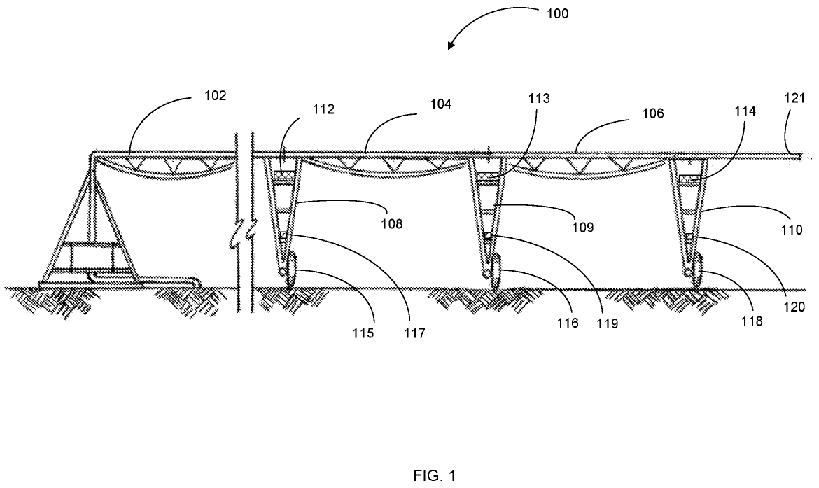

### DESCRIPTION OF THE PREFERRED EMBODIMENTS

Aspects of the present invention will be explained with reference to exemplary embodiments and examples which are illustrated in the accompanying drawings. These descriptions, embodiments and figures are not to be taken as limiting the scope of the claims. Further, the word “exemplary” is used herein to mean “serving as an example, instance, or illustration.” Accordingly, any embodiment described herein as “exemplary” is not to be construed as preferred over other embodiments. Additionally, well-known elements of the embodiments will not be described in detail or will be omitted so as not to obscure relevant details.

Where the specification describes advantages of an embodiment or limitations of other prior art, the applicant does not intend to disclaim or disavow any potential embodiments covered by the appended claims unless the applicant specifically states that it is “hereby disclaiming or disavowing” potential claim scope. Likewise, the term “embodiments” does not require that all embodiments of the invention include any discussed feature or advantage, nor that it does not incorporate aspects of the prior art which are sub-optimal or disadvantageous.

As used herein, the singular forms “a”, “an” and “the” are intended to include the plural forms as well, unless the context clearly indicates otherwise. Additionally, the word “may” is used in a permissive sense (i.e., meaning “having the potential to’), rather than the mandatory sense (i.e., meaning “must”). Further, it should also be understood that throughout this disclosure, unless logically required to be otherwise, where a process or method is shown or described, the steps of the method may be performed in any order (i.e., repetitively, iteratively or simultaneously) and selected steps may be omitted. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The terms “program,” “computer program,” “software application,” “module” and the like as used herein, are defined as a sequence of instructions designed for execution on a computer system. A program, computer program, module or software application may include a subroutine, a function, a procedure, an object implementation, an executable application, an applet, a servlet, a source code, an object code, a shared library, a dynamic load library and/or other sequence of instructions designed for execution on a computer system. A data storage means, as defined herein, includes many different types of computer readable media that allow a computer to read data therefrom and that maintain the data stored for the computer to be able to read the data again.

Aspects of the systems and methods described herein may be implemented as functionality programmed into any of a variety of circuitry, including programmable logic devices, microcontrollers with memory, embedded microprocessors, firmware, software, etc. Furthermore, aspects of the systems and methods may be embodied in microprocessors having software-based circuit emulation, discrete logic (sequential and combinatorial), custom devices, fuzzy (neutral network) logic, quantum devices, and hybrids of any of the above device types.

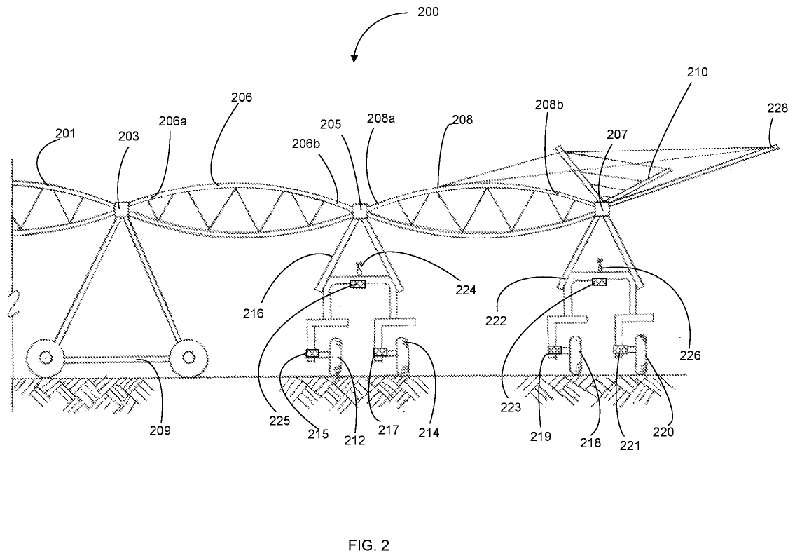

FIGS. 2-15 illustrate aspects of an exemplary self-propelled irrigation system which may be used with example implementations of the present invention. As should be understood, the irrigation system disclosed in FIGS. 2-15 are exemplary irrigation systems onto which the features of the present invention may be integrated. Accordingly, the figures are intended to be illustrative and any of a variety of systems (e.g., fixed systems as well as linear and center pivot self-propelled irrigation systems; corner systems) may be used with the present invention without limitation.

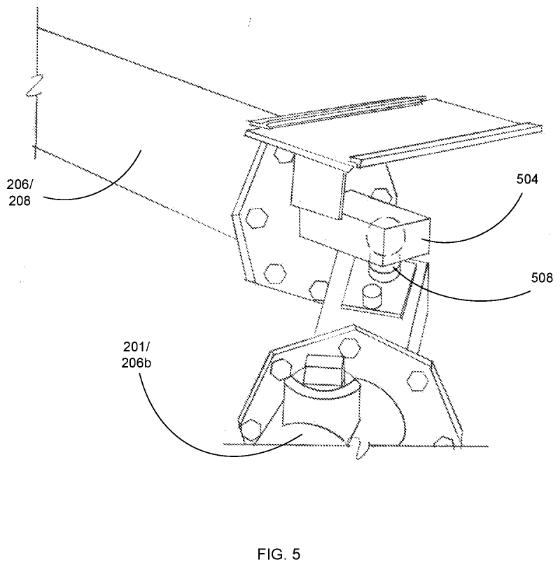

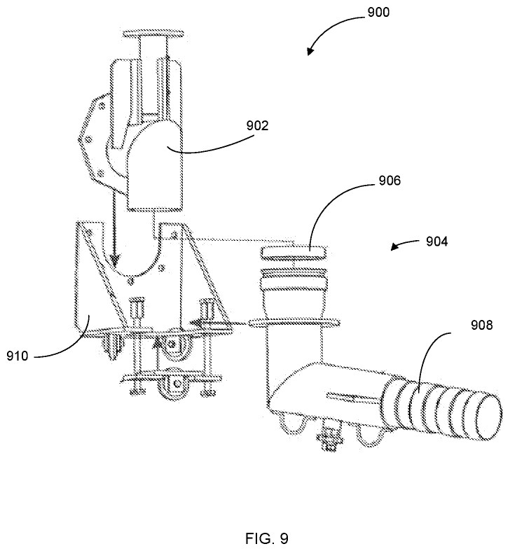

With reference now to FIG. 2, a further alternative embodiment 200 of the present invention is shown including multiple steerable drive towers 216, 222. As shown in FIG. 2, the exemplary alternative embodiment 200 may include a connecting joint 203 which connects the span(s) of the main section assembly 201 to a first articulated span 206. Preferably, the connecting joint 203 may be a ball joint such as a ball-and-socket pivot joint or the like as discussed with respect to FIG. 5 below. According to a first preferred embodiment, the connecting joint 203 may preferably be a “T-Bar” type of joint as discussed in FIG. 9 below. According to alternative preferred embodiments, the connection joint 203 may alternatively be any variation of swivel joint, pivot joint, hinge joint, ball joint, ball and/or pivot joint or the like.

As further shown in FIG. 2, the inner side 206a of the first articulated span 206 is preferably connected to connecting joint 203 and the outer side 206b is preferably connected to a second connecting joint 205. Extending further out, a second articulated span 208 is preferably connected to connecting joint 205 at an inner side 208a. According to a further preferred embodiment, an outer side 208b of the second articulated span 208 is preferably further connected to a connection point 207. According to alternative preferred embodiments, an extension boom 210 may preferably be further connected to connection point 207 and may support additional sprayers and/or an endgun (not shown). According to a further preferred embodiment, connection point 207 may preferably be fixed (i.e. bolted) so that the extension boom 210 (overhang) is fixed to the end of the second span at 208b such that it cannot articulate independently of span 208.

Preferably, the articulating spans 206, 208 are supported by drive towers 216, 222. As shown, a first drive tower 216 may preferably include one or more wheels 212, 214 which may be driven by a drive box 225 and one or more drive motors 215, 217. According to a preferred embodiment, the drive motors 215, 217 may be integrated together with wheel gearboxes (not shown) and positioned in a variety of locations. Likewise, a second drive tower 222 may preferably include one or more wheels 218, 220 which may be driven by a drive box 223 and one or more drive motors 219, 221.

According to a further preferred embodiment of the present invention, the wheels 212, 214 of the first drive tower 216 are preferably steerable. According to a further preferred embodiment, the wheels 218, 220 of the second drive tower 222 are preferably steerable. According to alternative preferred embodiments, each wheel of the present invention may be driven independently or in pairs via a common drive shaft.

According to further preferred embodiments, the spans 201, 206, 208 and drive towers 209, 216, 222 may be tracked and located via GPS receivers 224, 226 which may preferably be attached at points along the irrigation machine 200. As shown, GPS receivers 224, 226 may preferably be positioned at each drive unit to allow the system of the present invention to independently locate each drive tower 209, 216, 222. Additionally, the systems of the present invention may use the location and control systems discussed herein to control the movements of selected individual drive towers and to shape and position the irrigation system of the present invention. For example, the system of the present invention may pause/slow or speed up an inner drive unit and allow the irrigation machine 200 to bend in one direction or the other depending on selected pivot connections as discussed further below.

According to alternative preferred embodiments, spans 201, 206, 208 and drive towers 209, 216, 222 may be tracked and located using LORAN navigational aids, buried wire guidance and the like. According to a further preferred embodiment of the present invention, the guidance of each steerable drive tower 216, 222 may be directed by pre-stored data or data received from a remote GPS receiver, in combination with the above-mentioned tracked and location data from the GPS receivers, LORAN navigational aids and the like. According to a further preferred embodiment, sprinkler sequencing may preferably include controlled variable rate applications which may be controlled using detected GPS positions and/or the relative angles between the main section assembly 201 and the articulated spans 206, 208 as well as the relative angle between the articulated spans 206, 208, the angles of the tires 212, 214, 218, 220 relative to the drive towers 216, 222, as well as the rate of change of the angles or any combination thereof.

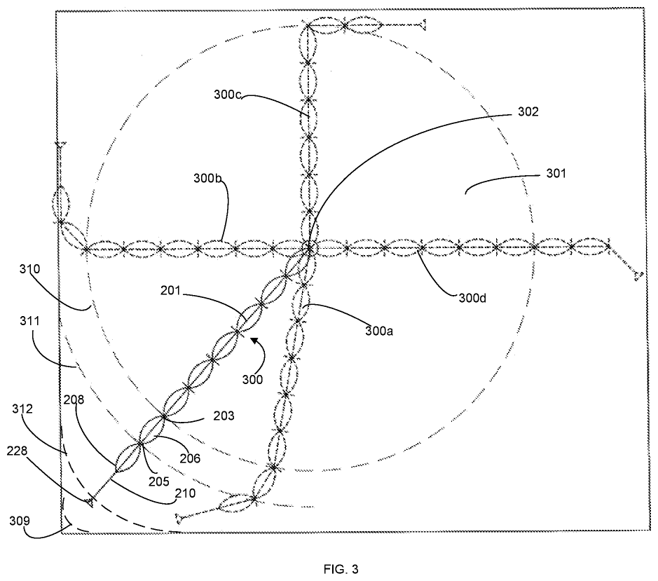

With reference now to FIG. 3, an overhead view of an exemplary irrigation machine 300 as shown in FIG. 2 is shown positioned to irrigate a given field 301. As shown in FIG. 3, the main section assembly 201 of the irrigation machine 300 preferably is pivotally connected to a central water source 302 so that the Last Regular Drive Tower (LRDU) of the main assembly runs along an optimal wheel track 310 centered on the field 301. The irrigation machine 300 as shown preferably further includes a connecting joint 203 which preferably connects the main section assembly 201 to a first articulated span 206. The irrigation machine 300 as shown preferably further includes a connection joint 205 which connects the first/corner articulated span 206 to the second/corner articulated span 208. As further shown in FIG. 3, the second articulated span 208 is preferably further connected to the extension span/overhang 210 via an 8-bolt pipe flange or the like.

According to preferred embodiments, in addition to connection points 203, 205 between end spans, a series of conventional ball and socket joints may preferably be used between the pivot point and each span of the regular machine. In this way, special joints as described above (e.g., pinned T-bar, ball and socket with extended range of angular motion about the horizontal plane, pendulum, track & roller etc.) may preferably be used between each irrigation span of the present invention as discussed further below.

Accordingly, as shown in FIG. 3, by employing aspects of the present invention, the articulating spans 206, 208 with the extension span/overhang 210 of the present invention may preferably irrigate out to wheel track 311 and extended area 312 and thus more fully cover the corners of any given field area. Further, an endgun 228 may preferably be used to extend irrigation further into the corners areas 309 of various fields. As shown, the irrigation machine 300 can move to a variety of different articulated positions 300a-d to achieve this purpose.

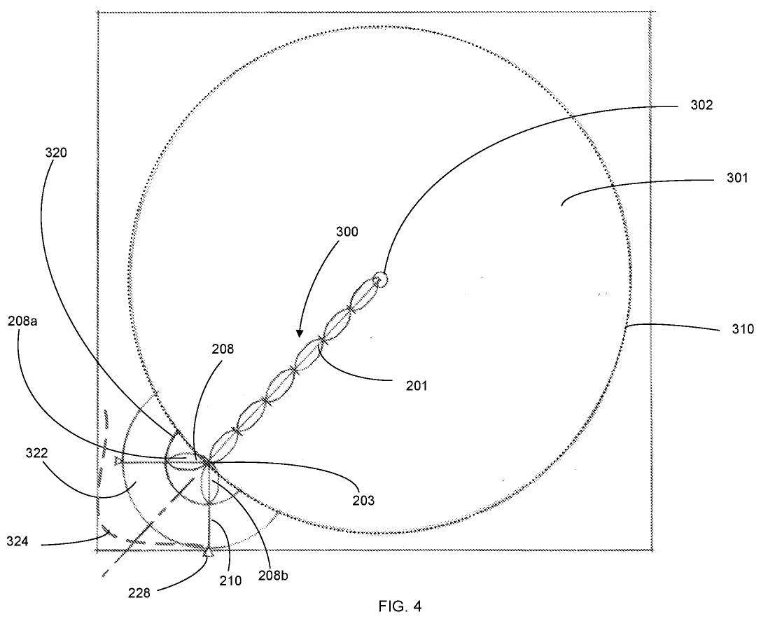

With reference now to FIG. 4, an illustration of the irrigation machine 300 shown in FIG. 3 is shown with the articulated span 208 in articulated positions 208a and 208b. As shown in FIG. 4, the irrigation machine 300 is shown with the main assembly 201 extended to water the field area 301 within its outer wheel track 310. As further shown, the articulated span 208 of FIG. 3 is shown moving along an extended wheel track 320 and in an exemplary first articulated position 208a and in a second articulated position 208b. As further illustrated, the extension span/overhang 210 of FIG. 3 is shown moving over extended area 322 to provide further irrigation. Still further, an endgun 228 is shown providing coverage over extended area 324. As shown, the articulated movements of the articulated span 208 preferably occurs as the main assembly 201 moves to provide complete coverage of the field area 301. According to alternative preferred embodiments, multiple articulated spans may be used and moved in the same manner to position the irrigation system as discussed further below.

Accordingly, as shown in FIGS. 3-4, the present invention provides significant additional field coverage to allow for consistent irrigation into the corners of a given field. This can result in significant amounts of acreage becoming available for irrigation and crop production. Further, the present invention greatly reduces overspray and the accompanying waste of water and other applicants.

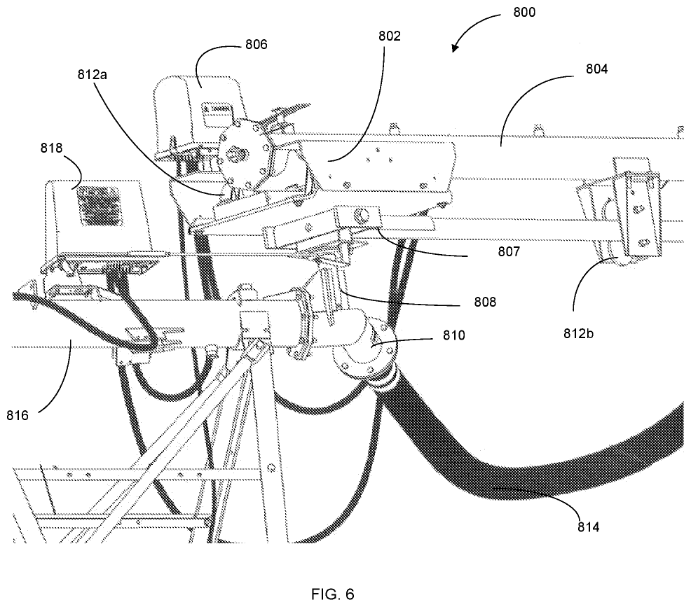

With reference now to FIGS. 5-9, example connection types are shown for use with the present invention. Such connection types may be used as any of connection points 203 and/or 205 discussed above. According to preferred embodiments, the connection types for use with the present invention (in particular connections 203 and 205) preferably may allow pivoting about a vertical axis as well as roll about a vertical axis to account for differential slopes between the spans (i.e., a ball and hitch design or the like). In addition, the connection points/joints for use with the present invention preferably may allow for small axial variance between the spans such as at 203. According to a further preferred embodiment, axial variance may be controlled by use of a track-and-roller, sensor controlled span crown variance, pendulum and/or similar designs such as the designs shown in FIG. 6-9.

With reference now to FIG. 5, a first example connection type is shown as a ball-and-socket joint 500 which connects a first socket connector 504 of an articulating span such as 206/208 to a ball connector 508 of a further inboard span such as the last span of the pivot 201 or the inner end of an articulating span 206b. This type of connector is preferably utilized with a sensor controlled span crown variance system. The example connection type is intended to be illustrative and not limiting to the present scope of the invention. Accordingly, it should be understood that any of a variety of different joint and connection elements may be used including: swivel joints, pivot joints, hinge joints, ball joints, and the like.

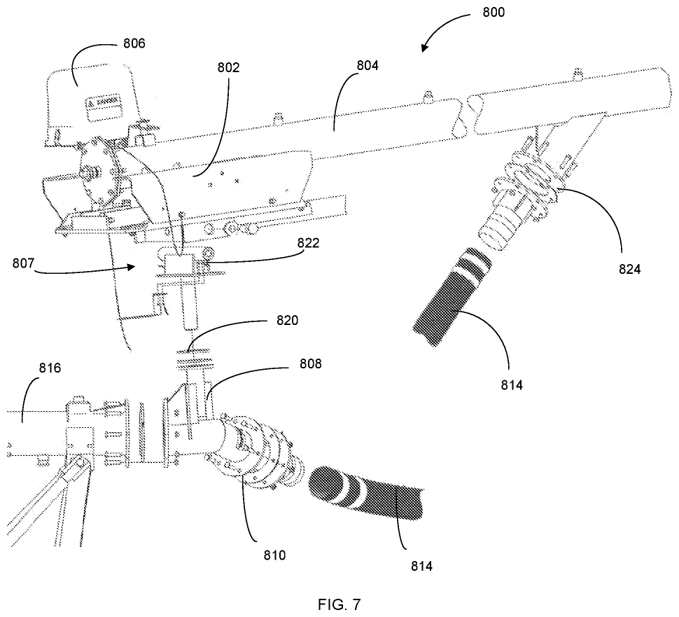

With reference now to FIGS. 6-9, an example articulating joint assembly 800 for use with connection points 203 and 205 is shown. As shown in FIGS. 6-8, an exemplary articulating joint assembly 800 may include a cradle assembly 802 for receiving and attaching an articulating span 804 to an outer span pipe 816. As shown, the cradle assembly 802 is preferably secured to the span pipe 816 via a securing assembly 807 attached to the cradle assembly 802 and further attached to a fixed retaining outlet 808 which is further secured to a stub assembly 810. As further shown, the joint assembly 800 may preferably further include roller assemblies 812a, 812b and a stub hose 814 to provide applicant from the last span pipe 816 to the articulating span 804 via a receiving stub assembly 824. As further shown, control systems such as a sprinkler control box 818 and a run cycle box 806 may be further provided and positioned as needed. As further shown in FIG. 7, an exemplary securing assembly 807 may preferably include a T-Bar assembly 822 which is secured to the cradle 802 and further secured through retaining washers 820 to a fixed retaining outlet 808. This T-Bar assembly preferably allows rotation about the vertical axis of the fixed retaining outlet 808 (to allow articulation of the span) as well as rotation about a horizontal axis perpendicular to the articulating span pipe 804 (to allow for elevation variations between the last span 816 drive unit and the articulating span 804 drive unit). Further, the roller assembly 812a, 812b preferably allow for small amounts of axial variation between the last span 816 pipe and the articulating span pipe 804 in order to compensate for minor variances in speed between fixed and steerable and steerable and steerable drive units as the irrigation machine moves through the cultivation area.

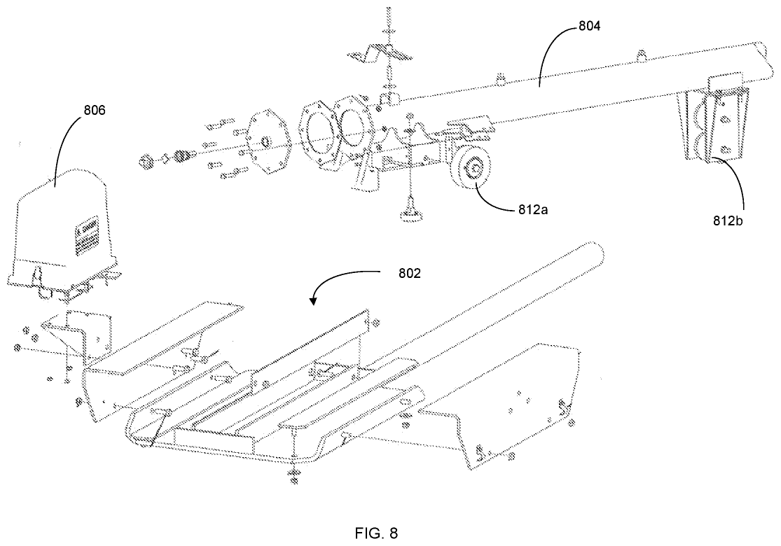

With reference now to FIG. 8, a further exploded view of the exemplary cradle assembly 802 is shown including a roller 812a and roller assembly 812b attached to the articulating span 804.

According to a preferred embodiment, the fixed retaining outlet 808 may preferably be fixed so that only the cradle assembly 802 via the T-Bar assembly 807 is allowed to move thus providing angular displacement between the articulating span 804 and the main span pipe 816. According to alternative preferred embodiments, a rotational connection may further be provided in place of the fixed retaining outlet 808 as shown in FIG. 9.

With reference now to FIG. 9, an exemplary rotational connection may be provided by a rotational retaining outlet 900. As shown, such an outlet 900 may preferably include an upper stub assembly 902 for attachment to a main span (not shown). Further, the outlet 900 may include a securing clamp assembly 910 for receiving a rotational stub assembly 904 which may further include a rotational ring gasket 906 and a lower stub assembly 908 for receiving a stub hose (not shown).

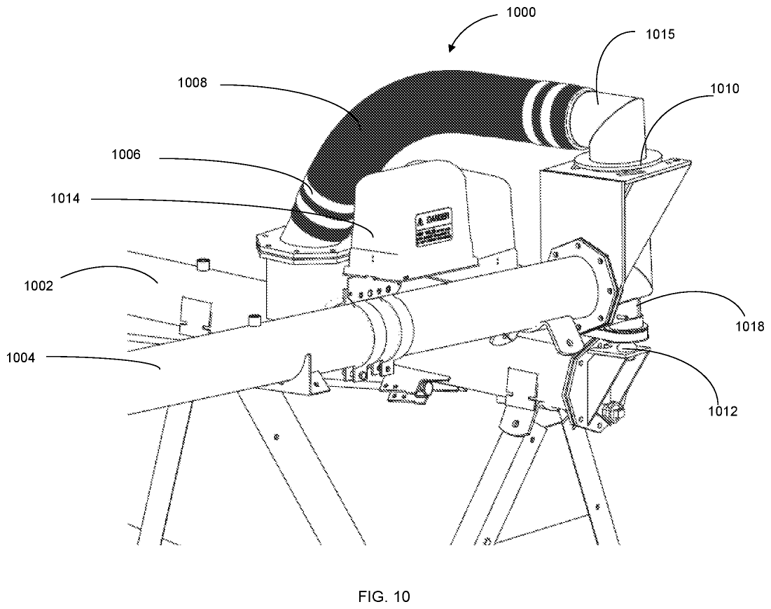

With reference now to FIGS. 10-12, an alternative example articulating joint assembly 1000 for use with one or more connection points of the present invention is shown. As shown, an exemplary articulating joint assembly 1000 may include a swivel and roller assembly 1010 for receiving and attaching an articulating or main span 1002 to an outer span pipe 1004. As shown, the articulating joint assembly 1000 preferably includes a coupler assembly 1018. The articulating joint assembly 1000 preferably further includes a transfer hose barb 1015 for attaching to a connecting hose 1008 which is further attached to a hose barb 1006 on the main irrigation span 1002. Additionally, a control/junction box 1014 is shown for controlling movement between the main span 1002 and the extension span 1004. Additionally, the articulating joint assembly 1000 is attached to a hitch ball 1012 connected to the main span 1002.

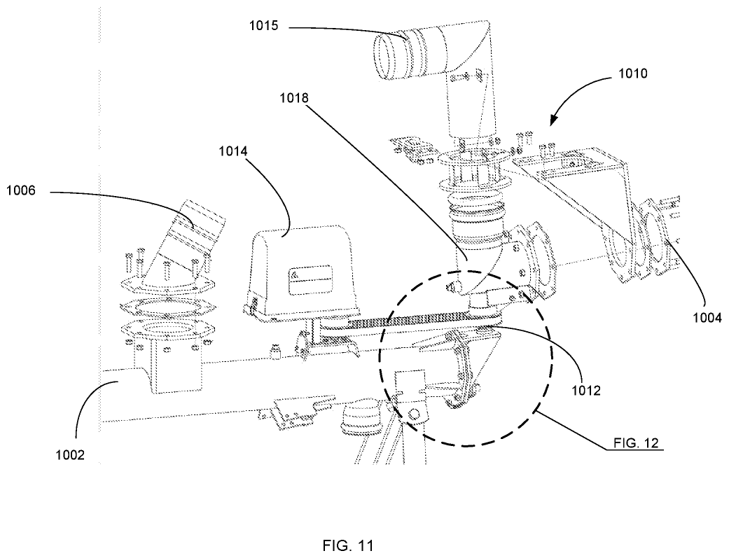

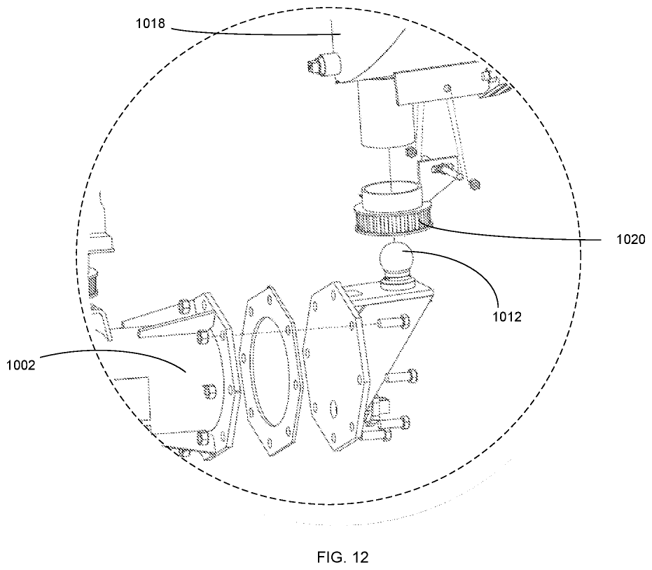

As shown in FIG. 12, the main span 1002 of the alternative example may preferably terminate in a hitch ball 1012. A tower box pulley 1020 may preferably be inserted over the hitch ball 1012. As further shown, a coupler assembly 1018 may preferably be inserted through the tower box pulley 1020 and over the hitch ball 1012. In this way, the connected spans 1002, 1004 may flex and articulate as discussed further herein.

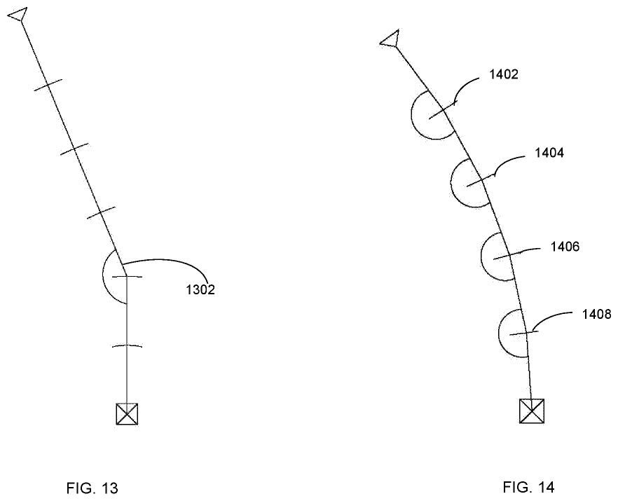

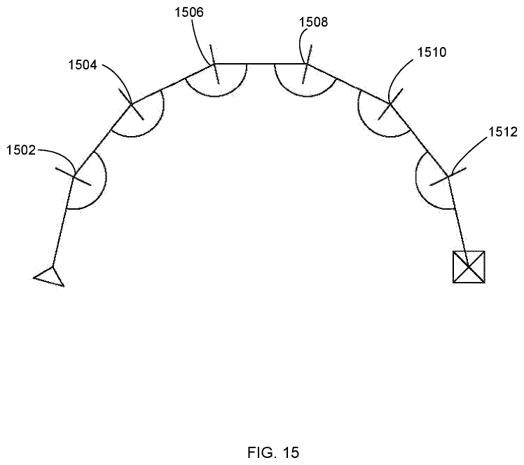

According to preferred embodiments, the connected spans of the present invention may articulate in any number of ways. Further, the relative positioning and resulting shapes of the connected irrigation spans may preferably be controlled, coordinated and prescribed by system controllers based on detected conditions, sensor inputs and/or times. With reference to FIG. 13, the connected spans may articulate at a single point 1302 using any of the connection systems discussed above. In this way, the connected spans may articulate at an angle of 0-90 degrees or more. As shown in FIG. 13, the connected spans may articulate at a single point 1302 at an angle of 30 degrees. As shown in FIG. 14, multiple connection points 1402-1408 of the present invention may be provided between various spans so that the connected spans may form a bending line with each of the connection points 1402-1408 articulating to various angles. As shown in FIG. 15, the angles at the connection points 1502-1512 may be complementary to allow the irrigation spans to form selected shapes to better withstand detected conditions (e.g., high winds or heavy rains).

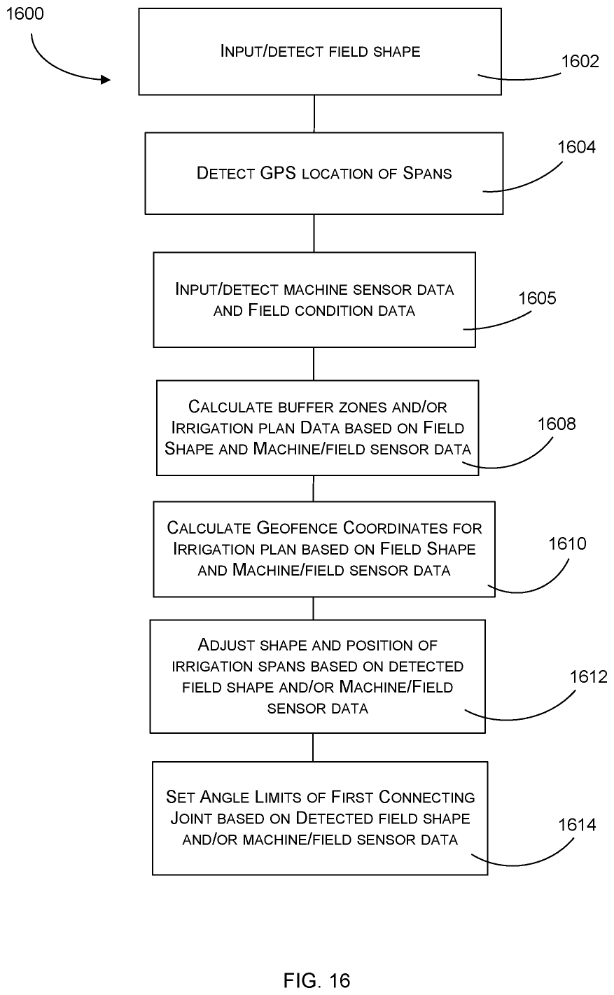

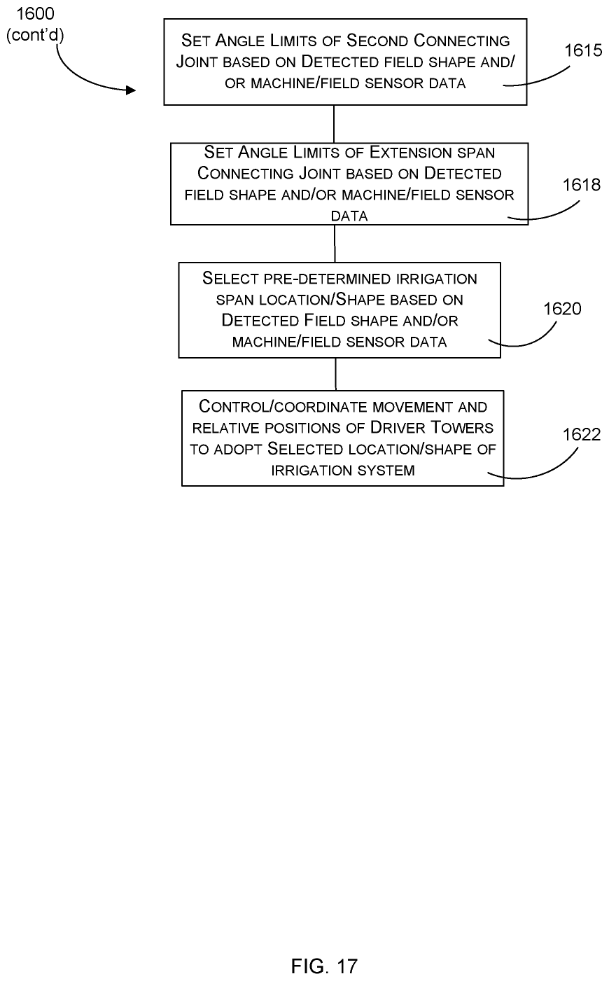

With reference now to FIGS. 16-17, exemplary methods for controlling an irrigation system shall now be discussed. At the first step 1602, the system of the present invention preferably receives an input indicating field shape or otherwise detects the field shape. At a next step 1604, the system of the present invention preferably detects the GPS location of each span in service. In the example provided, the system detects the locations of the first and second spans. According to preferred embodiments, GPS receivers (or other location detection systems) may be positioned at each drive unit to allow the present invention to independently locate each drive tower. Additionally, the location and control systems of the present invention may be used to control the movements of selected individual drive towers. For example, the system of the present invention may pause/slow or speed up one or more inner drive units to cause or allow the irrigation machine to bend in one direction or the other depending on a selected targeted shape of the irrigation system.

At a next step 1605, the system receives input data or otherwise detects and receives machine sensor data and field condition data. For example, sensor inputs from sensors such as gyroscopes, stress gauges, alignment sensors, wind sensors, traction sensors and the like may be used to detect and determine specific conditions. These conditions may include for example: an imbalance within an irrigation span or machine, loss of traction, increased wind speeds, blocked or stuck spans and the like.

With all data and system inputs received, the system at the next step 1608 may then preferably proceed to calculate any buffer zones and the path of the irrigation plan based on the field shape and machine/field sensor data received. At a next step 1610, the system may then calculate any needed geofence coordinates for the irrigation plan based on the detected field shape and machine/field sensor data. At a next step 1612, the system then may preferably adjust the shape and position of one or more irrigation spans based upon the detected field shape and/or machine/field sensor data. According to further preferred embodiments, different pivot connections may be use between each span or groups of spans to allow specific shapes and configurations to be achieved. For example, the pivot connections used may allow center spans to bend (i.e., move at the pivot connection to an alignment off-set from the adjacent, inner span) up to 30 degrees and outer spans to bend at greater angles (e.g. up to 160 degrees). Preferably, the system of the present invention may thus allow connected irrigation spans to conform around irregular or curved boundaries. Additionally, the present invention may allow an irrigation system to be parked in a curled up fashion in response to high winds, reduced travel space or other identified conditions. Preferably, the present invention may adjust the shapes and the relative positions of each drive tower/span in a given field without any barricades.

At a next step 1614, the system may then proceed to calculate and set angle limits for the first connecting joint based upon the detected field shape and machine/field sensor data. According to preferred embodiments, the angle limits for each connection point may be calculated and set/stored within each drive tower controller, connection joint (via servo motors or the like), central pivot controller or remote server without limitation.

At a next step 1615 (FIG. 17), the system may set angle limits for the second connecting joint again based on detected field shape and/or machine/field sensor data as discussed above with reference to step 1614. At a next step 1618, the system may then further set angle limits for any further attached extension span connecting joints.

At a next step 1620, the system may then proceed to select predetermined irrigation span locations and and/or shapes based on the detected field shape and/or any machine/field sensor data. According to preferred embodiments, the system of the present invention may be programmed with pre-determined shapes which may be stored by the system and initiated when detected conditions match predetermined thresholds. In response to these or other detected conditions, the irrigation span may selectively control individual drive towers and irrigation span angles to create responsive angles between irrigation spans and specific shapes across the entire irrigation machine such as those discussed above. At a next step 1622, the system may then proceed to control/coordinate movement of the drive towers and spans to adopt a given selected location/shape of the irrigation spans. The system may thereafter proceed to develop and calculate GPS/geofence coordinates for any updates to the irrigation plan made based upon the newly detected field shape and/or any machine/field sensor data.

The scope of the present invention should be determined not by the embodiments illustrated, but by the appended claims and their legal equivalents.

What is claimed is:

1. A system for use with a self-propelled irrigation system having at least one span and a drive system for moving the span, wherein the self-propelled irrigation system is connected to a water source, wherein the system comprises:
a main section assembly, wherein the main section assembly is comprised of one or more interconnected spans supported by one or more drive towers;
a first articulated span, wherein the first articulated span is comprised of an inner end and an outer end;
a first connecting joint, wherein the first connecting joint attaches the main section assembly to the water source; and
a first articulating joint; further wherein the first articulating joint is attached to the main section assembly; further wherein the first articulating joint is rotationally connected to the inner end of the first articulated span;
wherein the first articulating span is supported by a first drive tower; further wherein the first drive tower is steerable.

2. The system of claim 1, wherein the system further comprises a second articulated span; wherein the second articulated span is comprised of an inner end and an outer end.

3. The system of claim 2, wherein the second articulating span is supported by a second drive tower; further wherein the second drive tower is steerable.

4. The system of claim 3, wherein the system further comprises a second articulating joint.

5. The system of claim 4, wherein the second articulating join is comprised of a ball joint.

6. The system of claim 4, wherein the second articulating joint is rotationally attached to the outer end of the first articulated span.

7. The system of claim 6, wherein the second articulating joint is rotationally connected to the inner end of the second articulated span.

8. The system of claim 7, wherein the system further comprises an extension span.

9. The system of claim 8, wherein the system further comprises a third connecting joint; wherein the third connecting joint is connected to the outer end of the second articulated span; further wherein the third connecting joint is further attached to the extension span.

10. A method for controlling a self-propelled irrigation system having at least a first span, a second span and an extension span; wherein the irrigation system further comprises a first drive tower and a second drive tower for independently moving each span; wherein the irrigation system comprises a control system configured to control the movements of each drive tower; further wherein the irrigation system is connected to a water source; the method comprising:
receiving field shape input data; wherein the field shape input data comprises data indicating field shape and size;
detecting the GPS location of each connected span;
receiving input data, wherein the input data comprises machine sensor data and field condition data;
calculating an irrigation path based at least in part on the field shape and machine/field sensor data received;
adjusting the shape or position of each connected span based upon the detected field shape and/or machine/field sensor data;
calculating and setting angle limits for the first connecting joint based upon the detected field shape and machine/field sensor data;
calculating and setting angle limits for the second connecting joint again based on detected field shape and/or machine/field sensor data;
selecting predetermined irrigation span locations and irrigation machine shape based on the detected field shape and machine/field sensor data; and
selectively controlling individual drive towers to create angles between irrigation spans to adopt a given selected location/shape of the irrigation system.

11. The method of claim 10, wherein the GPS location of each span is independently detected.

12. The method of claim 11, wherein the data received comprises data generated by sensors selected from the group of sensors comprising: gyroscopes, stress gauges, alignment sensors, wind sensors, and traction sensors.

13. The method of claim 12, wherein the conditions are selected from the group of conditions comprising: an imbalance within the irrigation machine, loss of traction, increased wind speeds, stuck spans and malfunctioning motors.

14. The method of claim 13, wherein the method further comprises: calculating a buffer zone based on the field shape and machine/field sensor data.

15. The method of claim 14, wherein the method further comprises: calculating updated geofence coordinates for the irrigation plan based on the detected field shape and machine/field sensor data.

16. The method of claim 15, wherein the connected irrigation spans are positioned to curve around irregular or curved boundaries.

17. The method of claim 16, wherein the connected irrigation spans are parked in a curled up fashion in response to high winds or reduced travel space.

18. The method of claim 17, wherein the relative positions of each drive tower/span are adjusted to shape connected irrigation spans in the middle of a given field without any barricades.

19. The method of claim 18, wherein the method further comprises: calculating and setting set angle limits for the attached extension span connecting joints.

20. The method of claim 19, wherein at least one shape is stored by the system and initiated when detected conditions match predetermined thresholds.
